(19) United States
(12) Patent Application Publication
(10) Pub. No.: US 2005/0082912 A1
(43) Pub. Date: Apr. 21, 2005

(54) Power supply device for a tire-pressure sensor

(76) Inventors: Andreas Junger, Reutlingen (DE); Hubert Benzel, Pliezhausen (DE); Bernhard Zappel, Unterensignen (DE); Juergen Nitsche, Gammertingen (DE); Frank Schaefer, Tuebingen (DE); Heinz-Georg Vossenberg, Pfullingen (DE); Frieder Haag, Wannweil (DE); Regina Grote, Reutlingen (DE)

Correspondence Address: KENYON & KENYON, ONE BROADWAY, NEW YORK, NY, 10004, US

(21) Appl. No.: 10/756,931

(22) Filed: Jan. 13, 2004

(30) Foreign Application Priority Data
Jan. 15, 2003 (DE) 10301192.7

(51) Int. Cl. B60L 3/00

(52) U.S. Cl. 307/10.1

(57) ABSTRACT

A device for supplying power to a tire-pressure sensor, containing a generator that is corotational with the tire and in which an electric voltage is generated by electromagnetic induction.

### BACKGROUND INFORMATION

Tire-pressure sensors having batteries for power supply are known for motor vehicles. These sensors are located in the tire and include a sensor element whose output signal is encoded and transmitted by a transmitter to the receiver in the vehicle. One problem with these sensors is the power supply, usually a battery having a short lifetime. The toxic substances of which batteries are made are equally critical from the standpoint of possible disposal.

### SUMMARY OF THE INVENTION

The present invention relates to a power supply device for a tire-pressure sensor, including a generator which is corotational with the tire (i.e., fixedly mounted on the wheel or tire or valve) in which an electric voltage is generated by electromagnetic induction. This has the following advantages:
a long lifetime,
continuous operation is possible due to temporary storage of the power generated,
toxic substances are avoided by eliminating batteries,
simple installation is possible by mounting the device on the valve, and
small geometric dimensions of the system as a whole are possible by mounting, i.e., installing, the device on the valve.

An advantageous embodiment is characterized in that
the generator contains a magnetic circuit and
the induced voltage is generated by a geometric change in the magnetic circuit.
   A voltage is therefore generatable in a simple and robust manner.

An advantageous embodiment is characterized in that the geometric change in the magnetic circuit is achieved by a change in the air gaps.

Another advantageous embodiment is characterized in that the magnetic circuit contains at least one permanent magnet. This makes it possible to generate a magnetic field easily and without expending energy.

An advantageous embodiment is characterized in that the magnetic circuit
includes a stationary, magnetically conductive core, and
includes a movable, magnetically conductive core, and
the induced voltage is generated by a relative change in position of the movable core with respect to the stationary core.
   This advantageously permits a simple geometric construction.

An advantageous embodiment is characterized in that the movable core moves along a guide.

Another advantageous embodiment is characterized in that a restoring spring is mounted on the movable core for returning the movable core to its starting position after a relative change in position.

Another advantageous embodiment is characterized in that the movable core is mounted on a plate spring which allows a one-dimensional change in position of the movable core, i.e., the movable core can move along a curved path.

Another advantageous embodiment is characterized in that the movable core is mounted on a torsion bar which allows a two-dimensional change in position of the movable core, i.e., the movable core can move over a two-dimensional surface.

In all these embodiments mentioned last, inexpensive production is possible due to the use of field-tested components.

Another advantageous embodiment is characterized in that the size of the relative change in position is limited by at least one stop.

An advantageous embodiment is characterized in that the stationary core contains a coil in which the induced voltage is generated. Since the coil is mounted on the stationary core, the coil feeder lines do not move while the generator is in operation.

Another advantageous embodiment is characterized in that the relative change in position is caused by an acceleration and/or a change in acceleration of the tire.

An advantageous embodiment is characterized in that an electric current is generated by the electric voltage, resulting in a charge buildup in an energy storage mechanism (capacitor, battery, . . . ).

### BRIEF DESCRIPTION OF THE DRAWINGS

FIG. 1 shows a block diagram of the design of the present invention.

FIG. 2 shows a tire and the accelerations that occur.

FIG. 3 shows a first embodiment of the generator.

FIG. 4 shows a second embodiment of the generator.

FIG. 5 shows a third embodiment of the generator.

### DETAILED DESCRIPTION

While driving, sizeable accelerations occur in the wheels of motor vehicles. This includes centrifugal acceleration, which may be very high (up to approximately 400 g; g=gravitational acceleration), and other accelerations in the tangential direction as well as in the transverse direction of the vehicle. These accelerations are shown in FIG. 2, which shows on the left a side view of a wheel having a tire (rolling past the observer) and on the right a front view of a wheel having a tire (rolling toward the observer), where
200=tire,
201=rim,
202=valve,
203=seal, and
204=tire-pressure sensor.

In addition, FIG. 2 shows a tangential acceleration aₜ (acting in the circumferential direction of the wheel), a centrifugal acceleration a_{z} (acting radially outward) and a transverse acceleration a_{q} (acting in the transverse direction).

Essentially only centrifugal acceleration occurs at a constant driving speed on an ideally planar road surface. In reality, however, there are constant up and down movements and small lateral movements of the wheels due to minor or major irregularities in the road surface, resulting in changes in acceleration (e.g., in a tangential direction and transversely thereto). These changes in acceleration may be converted to electric power using the generator according to the present invention, i.e., used to generate electric power. The following changes in acceleration occur, for example:

1) centrifugal acceleration superimposed on twice the acceleration due to gravity plus a dynamic component in the radial direction:
a_{z}=a_{z0}+a_{zg}(t)+a_{zd}(t),
where
a_{z0} the centrifugal acceleration which is quasistatic in this discussion,
a_{zg}(t)=2*g*sin(ω*t), g=gravitational acceleration,
ω=angular frequency of the wheel,
a_{zd}(t) the dynamic component, e.g., resulting from irregularities in the road surface.

The contribution a_{zg}(t)=2*g*sin(ω*t) is very easily understandable due to the fact that gravitational acceleration g (in a fixed coordinate system) always points in the same direction, but the direction of the centrifugal acceleration acting on the generator is always changing in the same fixed coordinate system.

2) Changes in tangential acceleration occur, for example, in acceleration or deceleration of the vehicle and due to irregularities in road surface:
aₜ=aₜ₀+a_{td}(t), where aₜ₀≈0.

3) Transverse acceleration occurs, for example, when cornering or again due to irregularities in road surface:
a_{q}=a_{q0}+a_{qd}(t), where a_{q0}≈0.

Three embodiments of the generator are described below.

### EMBODIMENT 1

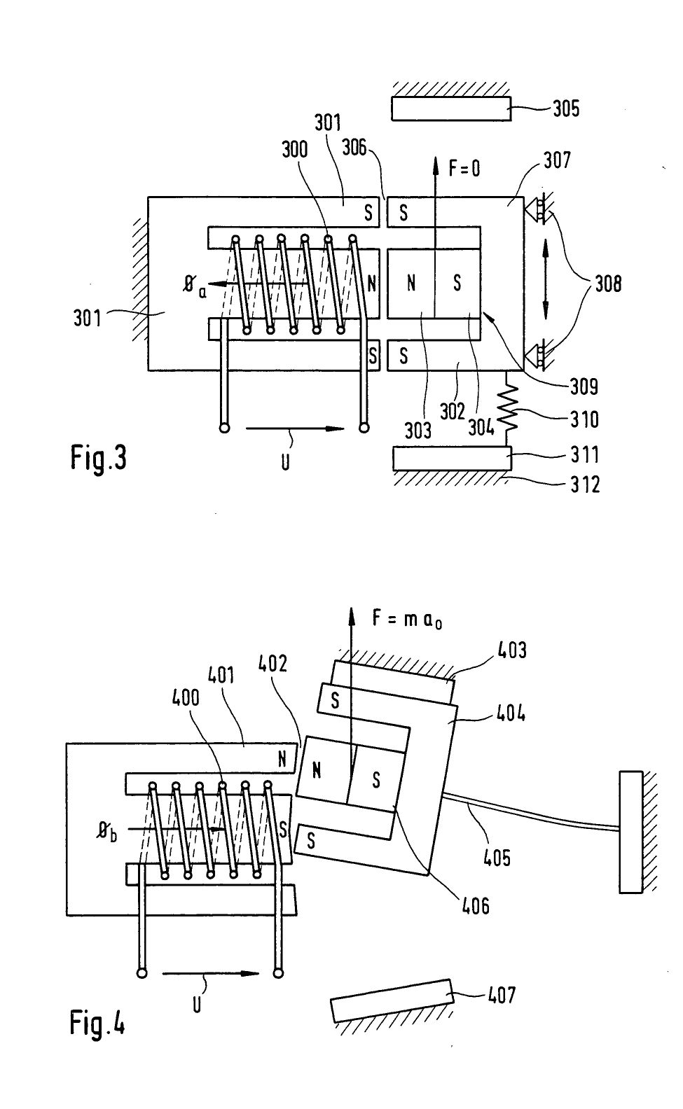

This embodiment is shown in FIG. 3. FIG. 3 shows a magnetic circuit composed of
stationary core 301,
movable core 307 with seismic mass m,
(small) air gap 306, which naturally changes due to the movement of core 307, and
permanent magnet 309, which has north pole 303 and south pole 304.

Movable core 307 moves along a guide 308. The movement is limited by upper stop 305 and lower stop 311, the fastening of the stops on the housing being labeled as 312. The return of the movable core to the starting position is accomplished by restoring spring 310.

If the movable core is moved up and down (due to changes in acceleration), then the magnetic flux through coil 300 changes (due to the change in magnetic circuit geometry and thus the change in magnetic resistance), so that a voltage U is induced in the coil. For effective operation, there should preferably be a small air gap between the poles. An upper stop and a lower stop prevent the spring from being overextended. Magnetic flux φ_{b} is induced in the coil.

### EMBODIMENT 2

This embodiment is shown in FIG. 4, where the following symbols are used (similarly to FIG. 3):

400=coil,

401=stationary core,

402=(small) air gap,

403=upper stop,

404=movable core having seismic mass m,

405=plate spring,

406=permanent magnet, and

407=lower stop.

Acceleration a₀ acts on the core having mass m, which is vibratingly mounted, and thus force F=m*a₀ acts on the core, resulting in deflection. The vibrating part is composed of the permanent magnet and a core made of a magnetically conductive material (e.g., iron or ferrite). Due to the movement of the core, there is a time-dependent magnetic flux through the coil and thus an induced voltage U=n*d(φ_{b})/dt. In the position of the movable core depicted in FIG. 4, magnetic flux φ_{b} flows through the coil in the direction shown. In the undeflected position (basically corresponding to the position shown in FIG. 3), the magnetic flux flows in the opposite direction, i.e., the magnetic flux also undergoes a change in sign.

### EMBODIMENT 3

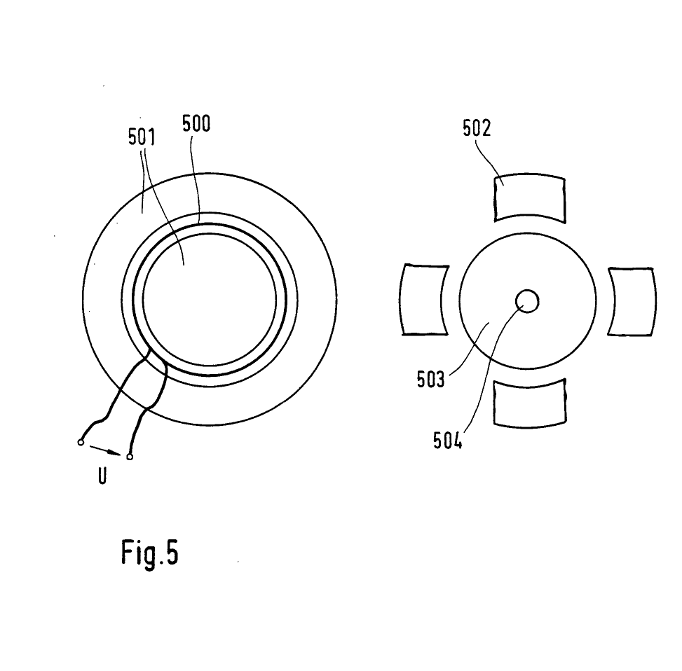

This embodiment is shown in FIG. 5, where

500=coil,

501=stationary core,

502=movable core,

503=permanent magnet,

504=torsion bar.

This embodiment is almost identical to that depicted in FIG. 4, essentially plate spring 405 being replaced by torsion bar 504. The seemingly complex but in principle very simple design of FIG. 5 will be explained first. The left half of FIG. 5 shows a top view of the stationary core and the coil from FIG. 4; the right half of FIG. 5 shows a top view of the movable core and the permanent magnet of FIG. 4. The differences include
the plate spring being replaced by a torsion bar and
the outer jacket of the movable core being divided into four segments.
   If the coil axis of the sensor is aligned in the radial direction, for example, then the changes in both the tangential acceleration and the transverse acceleration may be utilized to generate power. The segmented structure of outer jacket 502 is not necessary, but it allows greater differences in flux to be generated and thus higher induced voltages. This embodiment must also have a stop for limiting the deflecting movement.

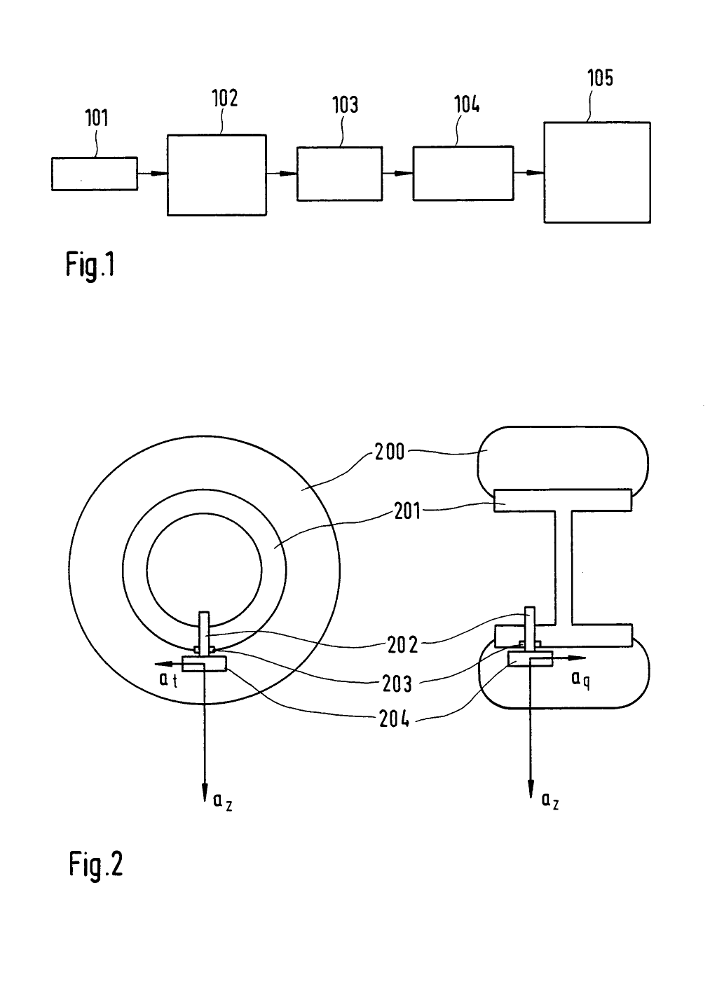

FIG. 1 shows how the power supply is embedded in the overall system, block 101 indicating the generator described above, its output voltage U, which is induced as a function of time, being sent to rectifier 102. Block 102 also includes a current limiter which might be necessary. This is followed by an energy storage device 103 (e.g., a battery or a capacitor) which is charged by the direct current supplied by block 102. Energy storage device 103 is followed by a voltage limiter 104, which is connected to pressure sensor 105. Block 105 also includes the analyzer circuit, the coder and the transmitter.

1. A power supply device of a tire-pressure sensor comprising:
a generator which is corotational with a tire, the generator generating an electric voltage by electromagnetic induction.

2. The device according to claim 1, wherein the generator includes a magnetic circuit, and the induced voltage is generated by a geometric change in the magnetic circuit.

3. The device according to claim 2, wherein the geometric change in the magnetic circuit includes a change in air gaps.

4. The device according to claim 2, wherein the magnetic circuit includes at least one permanent magnet.

5. The device according to claim 2, wherein the magnetic circuit includes a stationary magnetically-conductive core and a movable magnetically-conductive core, and the induced voltage is generated by a relative change in a position of the movable core with respect to the stationary core.

6. The device according to claim 5, further comprising a guide, and wherein the movable core moves along the guide.

7. The device according to claim 6, further comprising a restoring spring attached to the movable core for returning the movable core to a starting position after a relative change in position has occurred.

8. The device according to claim 5, further comprising a plate spring attached to the movable core for allowing a one-dimensional change in position of the movable core.

9. The device according to claim 5, further comprising a torsion bar attached to the movable core for allowing a two-dimensional change in position of the movable core.

10. The device according to claim 5, further comprising at least one stop for limiting a magnitude of the relative change in position.

11. The device according to claim 5, further comprising a coil, in which the induced voltage is generated, attached to the stationary core.

12. The device according to claim 5, wherein the relative change in position is induced by at least one of an acceleration and a change in acceleration of the tire.

13. The device according to claim 1, further comprising an energy storage device, and wherein an electric current is generated by the electric voltage and is used to charge up the energy storage device.
